(19) United States
(12) Patent Application Publication
(10) Pub. No.: US 2025/0094831 A1
(43) Pub. Date: Mar. 20, 2025

(54) POST-MODELING CATEGORY MERGING

(71) Applicant: International Business Machines Corporation, Armonk, NV (US)

(72) Inventors: Xue Ying Zhang, Xi'an (CN); Si Er Han, Xi'an (CN); Xiao Ming Ma, Xi'an (CN); Jing Xu, Xi'an (CN)

(73) Assignee: International Business Machines Corporation, Armonk, NY (US)

(21) Appl. No.: 18/370,613

(22) Filed: Sep. 20, 2023

(51) Int. Cl. G06N 5/022; G06N 5/04

(52) U.S. Cl. CPC G06N 5/022; G06N 5/04

(57) ABSTRACT

An embodiment identifies, by a post-modeling category merging engine, a plurality of valid pairs associated with a categorical predictor, the plurality of valid pairs representing potential mergers of categories associated with a categorical predictor of a predictive model. The embodiment tests, by the post-modeling category merging engine, a merge strategy for the plurality of valid pairs to determine a merger that minimizes a loss in accuracy of the predictive model. The embodiment merges, by the post-modeling category merging engine based on the testing, a valid pair in the plurality of valid pairs to form a hybrid category.

### BACKGROUND

The present invention relates generally to machine learning modeling. More particularly, the present invention relates to a method, system, and computer program for post-modeling category merging.

Feature importance is a concept used in machine learning to determine the significance of each predictor or feature in predicting the outcome of a target variable. When constructing predictive models, modelers can use multiple features or variables to explain or forecast the behavior of the target. By measuring the importance of each feature, modelers can identify which features most strongly influence the outcome, and which may be superfluous or less relevant. This can aid in refining and optimizing models by focusing on influential features and potentially reducing the complexity of the model.

### SUMMARY

The illustrative embodiments provide for post-modeling category merging.

An embodiment includes identifying a plurality of valid pairs associated with a categorical predictor, the plurality of valid pairs representing potential mergers of categories associated with a categorical predictor of a predictive model. This process offers a structured approach to recognizing potential combinations within the model's categories. By targeting valid pairs that represent meaningful potential mergers, the system can prioritize combinations that have a higher likelihood of enhancing model efficacy. This systematic identification saves computational resources, mitigates the risk of redundant processing, and potentially speeds up the optimization process.

The embodiment also includes testing a merge strategy for the plurality of valid pairs to determine a merger that minimizes a loss in accuracy of the predictive model. Rigorous testing of the merge strategy ensures that any decisions made in the subsequent processes are founded on quantifiable metrics and not just heuristic judgments. By focusing on minimizing the loss in accuracy, the model remains robust and reliable. This process ensures that the trade-off between model simplicity (through category mergers) and accuracy is continually calibrated to an optimal point, maintaining the model's predictive power while streamlining its components.

The embodiment also includes merging, based on the testing, a valid pair in the plurality of valid pairs to form a hybrid category. This implementation process fortifies the model by producing a hybrid category that is grounded in empirical analysis. By merging only after thorough testing, the system ensures that the new hybrid category not only retains but possibly even amplifies the information value from the original categories. It allows the model to evolve and refine itself while still retaining its foundational logic.

When viewed holistically, this embodiment crafts a powerful, systematic, and iterative approach to model refinement. It ensures that the predictive model remains at its optimal level of efficiency, without compromising on accuracy. By continually seeking out valid pairs, rigorously testing merger strategies, and then merging based on empirical evidence, the process maintains a balance between data gathering and model complexity and performance. This results in a modeling process that is both computationally efficient and highly reliable in its predictive capabilities.

In an embodiment, identifying the plurality of valid pairs further may include identifying a plurality of idle categories representing underutilized categories associated with the categorical predictor; merging the plurality of idle categories; and generating, based on a plurality of category importance values associated with a plurality of non-idle categories, the plurality of valid pairs. By targeting idle categories, which are essentially categories not contributing much to the predictive power, resources can be reallocated to improve model efficiency. Merging these idle categories based on their importance values ensures that the model remains streamlined and less prone to overfitting. This methodical approach increases the computational efficiency and potential interpretability of the model.

In an embodiment, identifying the plurality of idle categories further may include identifying a category as idle responsive to a determination that the category includes a zero count in a training dataset associated with the predictive model. This concrete criterion for identifying idle categories (zero count in training dataset) allows for objective and swift identification. This minimizes subjective biases and ensures consistent model refinement, enhancing the model's robustness and reproducibility.

In an embodiment, generating the plurality of valid pairs based on the plurality of category importance values further may include determining whether the categorical predictor is ordinal; and identifying as a valid pair, responsive to a determination that the categorical predictor is ordinal, two adjacent categories having a category importance value below a predetermined threshold. Recognizing the nature of the categorical predictor (ordinal or not) and adjusting the merging strategy accordingly ensures that inherent relationships within the data are respected. This nuanced approach maintains the integrity of the model's insights and ensures that predictive accuracy is not compromised due to oversimplification.

An embodiment also includes identifying as a valid pair, responsive to a determination that the categorical predictor is not ordinal, any two categories having a category importance value below a predetermined threshold. By having distinct strategies for ordinal and non-ordinal predictors, the model remains flexible. For non-ordinal predictors, this approach prioritizes merging based on importance, ensuring optimal resource allocation and improved computational efficiency.

In an embodiment, testing the merge strategy to determine the merger that minimizes the loss in accuracy of the predictive model further may include computing a plurality of model accuracy changes for a plurality of categories associated with the categorical predictor; sorting the plurality of model accuracy changes based on change magnitude; identifying a minimum model accuracy change in the sorted plurality of model accuracy changes; and determining to merge two categories associated with the minimum model accuracy change. This comprehensive evaluation process guarantees that the mergers leading to the least detrimental effects on accuracy are prioritized. By basing decisions on quantifiable accuracy changes, model stability and predictive power are upheld.

In an embodiment, the minimum model accuracy change is associated with a minimal decrease in accuracy for the predictive model. This criteria safeguards the model from making changes that significantly hamper its predictive prowess. It ensures that the most impactful categories remain untouched, preserving the model's core integrity.

In an embodiment, the minimum model accuracy change is associated with a maximum increase in accuracy for the predictive model. This perspective aims for optimization, actively seeking changes that boost the model's accuracy. It ensures that the model is always evolving towards better performance and finer precision.

An embodiment also includes identifying, by the post-modeling category merging engine, a plurality of hybrid valid pairs associated with the hybrid category of the categorical predictor; testing, by the post-modeling category merging engine, another merge strategy for the plurality of hybrid valid pairs to determine another merger that minimizes the loss in accuracy of the predictive model; and merging, by the post-modeling category merging engine based on the testing, a valid hybrid pair in the plurality of hybrid valid pairs to form another hybrid category. The iterative approach of identifying, testing, and merging using a specialized engine ensures continuous model refinement.

Cumulatively, these embodiments presents a sophisticated, dynamic, and adaptive approach to model refinement, focusing both on optimization and preservation of its predictive power. By diligently managing categorical predictors, optimizing their combinations, and rigorously testing strategies, the model becomes a powerful predictive tool. This process also simplifies the data gathering process for further refinement of the model, among other benefits.

An embodiment includes identifying a plurality of valid pairs associated with a categorical predictor, testing a merge strategy for these valid pairs to determine a merger that minimizes a loss in accuracy of the predictive model, and based on the testing, merging a valid pair to form a hybrid category. Additionally or alternatively, in this embodiment the identification of the plurality of valid pairs includes the steps of identifying a plurality of idle categories representing underutilized categories and merging these idle categories based on category importance values, which has a technical effect and/or advantage of refining the categorization by focusing on those categories that are underutilized, thereby streamlining the predictive model and enhancing its computational efficiency.

Another embodiment involves determining whether the categorical predictor is ordinal. If it is, two adjacent categories having a category importance value below a predetermined threshold are identified as a valid pair. If it is not, any two categories having a category importance value below the predetermined threshold are considered valid. Additionally or alternatively, in this embodiment the categorical predictor's nature is taken into account for generating valid pairs, helping ensure that inherent relationships within the data are upheld. This method, based on whether the predictor is ordinal or not, ensures that the model's insights are retained and accuracy is not compromised due to oversimplification.

The entire combination, when applied systematically, ensures a predictive model that is not only efficient in its operation but is also robust and adaptive. The iterative methodology in refining category combinations ensures the model's relevancy and peak performance over time. Specifically, focusing on underutilized categories by merging them based on importance values allows for optimal resource allocation, thus reducing the chances of overfitting. Moreover, recognizing the nature of categorical predictors and adjusting merging strategies accordingly ensures a balanced approach that neither oversimplifies nor overcomplicates the model, preserving its accuracy.

Consider a scenario in a healthcare setting where the predictive model aims to forecast patient outcomes based on a range of variables, including symptoms, medical history, and genetic factors. In such a case, many symptoms (categorical predictors) might be rarely reported (idle categories). By following the methodology, the system could merge these rare symptoms into hybrid categories that still provide insight without overcomplicating the model. For instance, if the categorical predictor is the “symptom type,” and the model recognizes it as ordinal (symptoms ranked based on severity), it would prioritize merging adjacent symptoms that are less frequently reported. On the other hand, if the “genetic factors” predictor is non-ordinal, the system would merge based on the importance values, ensuring that the most critical genetic factors remain distinct. This approach ensures that the predictive model remains efficient and relevant in real-world healthcare settings, providing accurate forecasts even as patient data evolves and grows.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example process for post-modeling category merging in accordance with an illustrative embodiment.

FIG. 4 depicts a block diagram of an example process for identification of valid pairs in accordance with an illustrative embodiment.

FIG. 5 depicts a block diagram of an example process for testing a category merging strategy in accordance with an illustrative embodiment.

FIG. 6 depicts a block diagram of an example process for forming a set of valid pairs for a hybrid category in accordance with an illustrative embodiment.

FIG. 7 depicts a block diagram of an example result of identifying valid pairs in accordance with an illustrative embodiment.

FIG. 8 depicts a block diagram of an example result of merging valid pairs to generate hybrid categories in accordance with an illustrative embodiment.

FIG. 9 depicts a block diagram of an example result of merging valid pairs of a categorical predictor with hybrid categories in accordance with an illustrative embodiment.

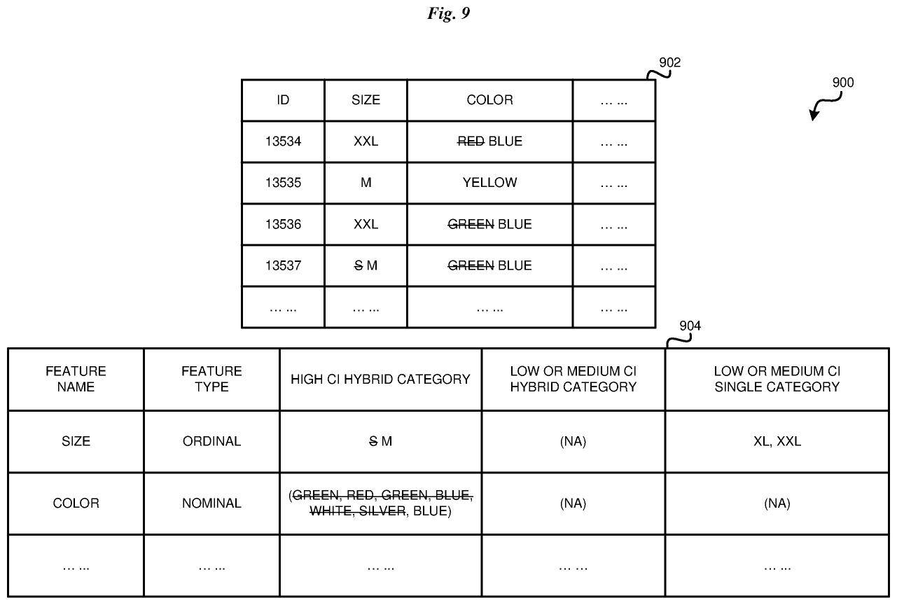

FIG. 10 depicts a block diagram of an example process for post-modeling category merging in accordance with an illustrative embodiment.

### DETAILED DESCRIPTION

In the realm of machine learning and data analysis, the construction of predictive models may involve the use of various input variables, commonly known as features, to make predictions about a certain outcome or target variable. As these models are trained on data, they assign varying levels of importance to each feature based on how significantly that feature influences the prediction. Feature importance is a metric that quantifies the contribution of each feature to the model's predictive capability. By evaluating feature importance, data scientists and analysts can gain insights into which variables play a critical role in the model's predictions and which ones might be less relevant.

While feature importance gives a high-level overview of which features are important, it does not always provide the nuance or granularity that modelers might desire. Often, it is not just the importance of the feature but also how different values or categories of that feature influence the target variable. The given single value of importance can be limiting as it does not specify how different categories or values within that feature correlate with different outcomes. Hence, delving deeper into the feature's specific interactions and effects can offer richer insights and enhance model understanding.

Consider the predictor “outfit color.” This predictor may be categorical in nature, meaning it takes on discrete values like “green,” “gray,” “yellow,” and “blue.” Each of these categories can influence the target variable differently. Knowing only the overall importance of “outfit color” might suggest it is a significant predictor, but without understanding how each color interacts with the target, one might miss out on key information. For instance, if only the category “yellow” leads to a “Yes” for the target “Insect attraction,” while all other colors result in a “No,” it may be crucial for model interpretation and for making informed decisions based on the model's output.

Such detailed insights into feature interactions can be valuable. For one, they can guide data collection efforts. Using the previous example, if researchers are specifically interested in instances where “Insect attraction” is “Yes,” they might prioritize collecting data with the “yellow” category for the “outfit color” predictor. Moreover, understanding these intricate relationships can also aid in refining the model, allowing for tweaks and optimizations to improve its accuracy and interpretability. It emphasizes the importance of not just relying on broad metrics but also seeking out the finer details in feature behavior.

Current methods of determining feature importance commonly lack the capability to dive deep into the nuances of categorical variables. While they might inform which features are influential in models, they typically do not facilitate a deep dive into how various categories within those features contribute to predictions. Without this granularity, there may be an absence of understanding about possible redundancies or similarities between categories, leading to missed opportunities for optimization. For instance, while a model might highlight the significance of a feature, existing systems may not have mechanisms to suggest potential category mergers that could simplify the feature space and maintain or even enhance the predictive power.

Moreover, existing systems tend to be static in their approach to feature evaluation. They often focus on the initial feature set's importance without the flexibility to iteratively refine the feature space. In real-world scenarios, especially with categorical data, some categories might exhibit very similar behavioral patterns with respect to the target variable. Overlooking these patterns may mean that data scientists and modelers might be spending unnecessary effort on data collection and preprocessing for categories that could have been merged or optimized. This static approach can hence be resource-intensive, potentially leading to inefficiencies in both model training and application.

The present disclosure addresses the deficiencies described above by providing a process (as well as a system, method, machine-readable medium, etc.) that tests and performs category merging based on post-modeling category importance. This innovative approach not only offers deeper insights for data understanding but also has the potential to significantly reduce data collection and preprocessing efforts. The process may involve using metadata information and category importance values to pinpoint valid pairs of candidate categories, evaluating the merging strategy for a given valid pair based on its impact on model accuracy changes, and the discovery of salient categories stemming from these newly crafted hybrid categories.

Illustrative embodiments provide for use of a post-modeling category merging engine. A “post-modeling category merging engine,” as used herein, may refer to a specialized computational module or system designed to operate after the deployment of a predictive model. This engine may have the function of refining, consolidating, and optimizing categorical variables to enhance the predictive capabilities and efficiency of the model. Its role may be helpful in contexts where categorical variables have significant influence on model outcomes, and there is a need to manage their granularity and interactions. For example, it may employ advanced algorithms that utilize techniques from machine learning and data mining to determine the optimal merging strategies. This engine might integrate with existing predictive models, ensuring that no significant reconfiguration of the model is necessary. Its design might incorporate features for scalability, making it adaptable to datasets of varying sizes, from small-scale projects to big data applications. Moreover, this engine could also provide real-time feedback, allowing users to monitor the effects of category merging on model performance immediately.

Illustrative embodiments provide for identifying a plurality of valid pairs associated with a categorical predictor of a predictive model. A “predictive model,” as used herein, may refer to a computational or algorithmic structure that forecasts or predicts events, behaviors, or outcomes. Such models rely heavily on predictors or features, which influence the prediction outcome. For example, these models could be built using various machine learning algorithms such as decision trees, neural networks, or ensemble methods, among others. The model's architecture and hyperparameters might be fine-tuned using cross-validation techniques to ensure optimal performance. Moreover, these predictive models could be deployed in cloud environments, enabling scalability and easy access for users across different platforms. The models might also incorporate regular updating mechanisms, ensuring that as new data becomes available, the model's predictions remain accurate and relevant.

A “categorical predictor,” as used herein, may refer to a variable or feature that has a finite and distinct set of values or categories. Instead of continuous values, these predictors may hold classifications or labels. For example, these predictors could be stored in columnar databases for efficient retrieval and processing. Techniques such as one-hot encoding or label encoding might be employed to convert these categorical values into a format suitable for machine learning algorithms. Additionally, during preprocessing, categorical predictors might be subjected to operations like binning or grouping to create broader categories, such as when certain categories have sparse data.

A “valid pair,” as used herein, may refer to a pair of categories or values from a categorical predictor that meets specific criteria, making them eligible for merging or any other subsequent analytical operation. The criteria could be based on various metrics such as relevance, frequency, or their potential impact on the predictive model. Identifying a plurality of valid pairs associated with a categorical predictor may involve computational and/or heuristic steps, designed to sieve through the plethora of categories associated with the predictor. This identification process may help ensure that only those pairs that hold relevance and promise in terms of improving model accuracy are retained. For example, while forming valid pairs, heuristic algorithms or deep learning models could be deployed to determine the most optimal pairs to merge. Moreover, these algorithms might assess various metrics, such as the mutual information between pairs, their combined frequency, or potential impact on the target variable. Additionally, validation techniques, like bootstrapping or permutation tests, could be used to ascertain the statistical significance of the identified pairs. This ensures that the merged pairs genuinely contribute to enhancing the model's predictive power.

In some embodiments, for example, identifying the plurality of valid pairs may involve identifying a plurality of idle categories, merging the plurality of idle categories, and generating valid pairs based on category importance values associated with non-idle categories. An “idle category,” as used herein, may represent an underutilized category associated with the categorical predictor. Such categories might not significantly influence the model outcomes due to their limited presence or impact. For example, analytics tools might be employed to visualize the distribution and prevalence of each category in the dataset. Such visualizations could aid in quickly spotting categories with minimal or zero representation. Furthermore, anomaly detection algorithms could be utilized to flag categories that deviate significantly from expected behavior or frequency. These algorithms could be adaptive, learning from continuously incoming data and refining their criteria for what constitutes an “idle” category.

Identifying a plurality of idle categories may involve determining which categories contribute minimally to the model's predictions. In some embodiments, for example, identifying the plurality of idle categories may involve identifying a category as idle when it includes a zero count in a training dataset associated with the predictive model. For example, this process might involve creating frequency tables or histograms that tabulate the occurrence of each category. If databases are used to store the training data, for example, structured query language (SQL) queries with specific “COUNT” conditions might be executed to swiftly identify such categories. Moreover, in situations where the dataset is vast, distributed computing frameworks could be harnessed to process the data in parallel and identify idle categories in a time-efficient manner. Other techniques may be used, however, as would be appreciated by those having ordinary skill in the art upon reviewing the present disclosure.

Merging the plurality of idle categories may involve refining the structure and efficiency of a predictive model. By amalgamating categories that are underrepresented or lack significant distinguishing features, one can streamline the model, thereby potentially enhancing its performance. This process may employ various techniques, ranging from simple aggregation to more sophisticated clustering methods that consider the nuances of each category. The ultimate goal may be to ensure that the newly formed merged categories retain meaningful information that contributes to the model's accuracy. For example, when merging the plurality of idle categories, the system might utilize clustering algorithms, such as K-means or hierarchical clustering, to group similar idle categories based on certain characteristics. This could be based on shared attributes, frequency distributions, or their relation to the outcome variable in the dataset. Techniques like silhouette analysis or the elbow method might be employed to determine the optimal number of clusters or merged categories, ensuring that each newly formed category is statistically distinct and relevant.

A “category importance value,” as used herein, may refer to a metric or score that quantifies the significance or relevance of a particular category within the dataset. This value may provide insights into how influential a category is in determining the outcome of a predictive model. The significance of each category can be gauged based on its frequency, its relationship with the target variable, or other statistical measures. Establishing a category's importance may help that the most pertinent information is retained, while redundant or less crucial data can be minimized or merged. For example, the calculation could integrate features like entropy measures, Gini impurity, or mutual information metrics to determine how much each category influences the predictability of the model. Models may employ ensemble techniques, such as random forests, which inherently compute feature importance, offering a clear picture of which categories contribute the most to the model's predictions.

Depending on the nature of the data and the requirements of the predictive model, different methods may be employed to calculate a category importance value. These might include frequency analysis, correlation measures, or even machine learning algorithms that can discern patterns and relationships within the data. The calculation may provide a standardized way to evaluate each category's contribution to the overall model. For example, in some embodiments, category importance values may be computed using one or more algorithms as outlined in U.S. application Ser. No. 18/333,510, filed Jun. 12, 2023. Other processes may be used, however, depending on the particular application or use. For example, the system might also consider the interaction effects between different categories. Factor analysis or principal component analysis could be used to understand underlying structures or shared variances between categories. These analyses would offer a holistic view of the dataset, highlighting not just individual category importance but also the synergistic effects of category combinations.

Generating valid pairs based on category importance values associated with non-idle categories may involve evaluating each category against its assigned importance value and then determining suitable pairings. This pairing mechanism ensures that the combined categories are coherent and that the resultant pairs retain maximum predictive power. The goal may not only be to simplify the model but also to enhance its data collection efficacy by ensuring that merged categories are meaningful. For example, techniques like association rule mining or pairwise correlation matrices could be invoked. These could identify strong associations or correlations between non-idle categories, ensuring that the merged categories have coherent and meaningful relationships.

In some embodiments, for example, categories with high category importance values (e.g., above a predetermined threshold) may be removed, and only those with low or medium category importance values (e.g., below a predetermined threshold) may be used to generate valid pairs. By focusing on these categories, the process may help ensure that the resultant valid pairs are well-structured and optimized for the predictive model's performance. For example, when excluding high-importance categories and focusing on the medium and low ones, one could leverage outlier detection techniques to identify categories that exhibit extreme behavior or importance values. Methods like the Tukey method or the Modified Z-score could also be used to detect these outliers, thereby delineating the high-importance categories from the rest. This ensures that only the most suitable categories are considered for the pairing, optimizing the predictive power of the merged categories.

Illustrative embodiments provide for testing a merge strategy for plurality of valid pairs to determine a merger that minimizes a loss in accuracy of the predictive model. Such an approach may aim to balance the benefits of category merging, such as simplification and data gathering efficiency, with the primary objective of preserving the model's prediction accuracy. Implementing this may involve identifying suitable categories to merge, and then evaluating how this potential merger impacts the model. For example, when testing a merge strategy for a multitude of valid pairs, one might employ cross-validation techniques to evaluate the model's performance across different segments of the data. By using folds, the strategy can be repeatedly assessed under varied conditions, ensuring a comprehensive evaluation. Techniques like k-fold or stratified cross-validation would be appropriate choices, especially when the dataset has imbalances or inherent structures that need to be maintained during testing.

Determining a loss (or gain) in accuracy of a predictive model may involve comparing the model's performance metrics before and after a merger. Metrics like Mean Absolute Error, Root Mean Squared Error, or classification accuracy could be utilized, depending on the nature of the model. By quantifying the change in these metrics, one can gauge the impact of the merger on the model's performance, thus enabling informed decision-making. For example, determining a loss (or gain) in the accuracy of a predictive model may involve the use of confusion matrices and receiver operating characteristic (ROC) curves for classification tasks. These tools may provide a holistic view of how well the model classifies each category post-merger. In regression models, residual plots might be used to visualize the distribution of errors pre- and post-merger, allowing for a nuanced understanding of how the merger impacts the distribution and magnitude of prediction errors.

A “merger,” as used herein, may refer to the act of combining two or more categories from a set, resulting in a modified or “hybrid” categorical structure. This combination aims to improve efficiency or clarity, but it is essential that it does not distort the original information or the relationships within the data. For example, in the context of a merger, the combined category might inherit properties, labels, or weights from its constituent categories based on certain rules. If two categories like “small” and “medium” in a size attribute are merged, the resulting label might be “medium,” “small medium,” or any other label, or the merger could be based on the frequency of occurrences, with dominant categories influencing the resulting merged category label.

A “merge strategy,” as used herein, may refer to a systematic approach or a set of guidelines that dictate how categories should be combined. This strategy is formulated based on certain principles, be it statistical significance, domain-specific insights, or the objective of the modeling task. It provides a roadmap, ensuring that the merging process is consistent, meaningful, and aligns with the overarching goals of the predictive modeling exercise. For example, crafting a merge strategy could involve the use of hierarchical clustering techniques to understand the natural groupings within categories. Dendrograms resulting from such clustering can give insights into which categories are closely related and thus more apt for merging. Furthermore, domain knowledge might be integrated into the strategy, ensuring that the mergers make sense from a business or scientific perspective.

Testing a merge strategy may involve applying the merging guidelines on a sample or the entire dataset and then observing how these changes influence the model's outcomes. The testing phase may be iterative, allowing for adjustments and refinements based on the feedback from each test run. This continuous feedback loop may help that the strategy is robust and achieves the desired results. For example, during the testing phase of a merge strategy, one might utilize bootstrapping methods to simulate different scenarios. This process might involve resampling the dataset multiple times and applying the merge strategy to each sample. By analyzing the distribution of model performance across these samples, one can gain insights into the stability and robustness of the proposed strategy under varied conditions.

In some embodiments, for example, testing the merge strategy may involve computing model accuracy changes for categories, sorting these changes by change magnitude, identifying the minimum accuracy change, and determining to merge two categories associated with this minimum change. This detailed assessment may help in identifying the merger that results in the minimum change in accuracy. Upon pinpointing this minimum accuracy change, a decision can be made to merge the two categories associated with this change, ensuring the integrity of the model's predictive power.

Computing a model accuracy change may involve comparing the model's performance metrics before and after implementing a specific merger. This difference, whether a gain or loss in accuracy, provides insights into how a particular merger influences the model's capabilities. For example, when computing model accuracy changes, differential analysis techniques can be applied to understand the underlying reasons for performance shifts. This might involve studying feature importance rankings, coefficients, or decision boundaries pre- and post-merger, thereby shedding light on how the merger influences the model's internal logic and decision-making processes.

Sorting model accuracy changes by change magnitude may involve using algorithms that rank changes from the smallest to the largest or vice-versa. Through this organized representation, it may become simpler to identify mergers that are beneficial or detrimental to the model's accuracy, guiding further iterations and refinements. For example, sorting model accuracy changes by magnitude could be implemented using efficient sorting algorithms. Moreover, the sorted list might be visualized using bar graphs or heat maps, with color-coding to highlight the mergers that result in the most significant performance changes, facilitating rapid identification and decision-making.

Identifying the minimum accuracy change may involve analyzing a distribution of accuracy changes across various proposed category mergers. By assessing the range of these changes, one can pinpoint the smallest deviation from the original model's performance. Such an analysis can be facilitated through computational methods or visual representations like scatter plots, which emphasize the magnitude and direction of every accuracy change. Efficient search algorithms can then be used to locate this minimum value within the dataset. For example, when identifying the minimum accuracy change, statistical tools and software can be employed to facilitate this process. Using regression analysis or outlier detection methods, the dataset can be thoroughly assessed to pinpoint any unexpected shifts in model accuracy. Moreover, employing machine learning techniques such as clustering might help segregate categories based on their impact on model accuracy. This systematic approach may help ensure that every potential merger is evaluated against its impact on model fidelity.

In some embodiments, the minimum model accuracy change may represent a minimal decrease in the predictive model's accuracy. This may represent a minimal disruption to the predictive model's performance. This signifies that the merger of categories, while causing a reduction in model accuracy, does not substantially hamper its predictive capabilities. In some other embodiments, however, the minimum model accuracy change may represent a maximum increase in the predictive model's accuracy. This may represent a gain in the predictive model's performance. This implies that the merged categories not only simplify the model but also enhance its predictive prowess.

Illustrative embodiments provide for merging a valid pair to form a hybrid category. A “hybrid category,” as used herein, may refer to a new category created by combining two distinct categories that share certain attributes or characteristics. For example, when aiming to merge a valid pair to form a hybrid category, the system could employ an algorithmic approach to determine the optimal manner in which these categories should be combined. This might entail assessing how closely related the data points within each category are or utilizing a clustering algorithm to confirm that the merger does not introduce significant variance within the new hybrid category. The efficacy of the merger might also be cross-validated with other independent datasets to gauge its universality.

Illustrative embodiments provide for generating the plurality of valid pairs based on whether the categorical predictor is ordinal. An “ordinal” category, as used herein, may refer to a category where the order of the values carries a meaningful distinction. Such categories typically have a clear hierarchy or sequence, unlike nominal categories where no such inherent order exists. Ordinality might be obtained from metadata. In some embodiments, however, algorithms could be employed to determine ordinality. For example, when diving into the mechanics of discerning ordinality within categorical predictors, machine learning models might be utilized. These models could be trained to detect patterns that signify ordered sequences, differentiating them from patterns that merely arise out of chance. Algorithms could analyze sequences, looking for gradations, consistent increments, or decrements.

Once the determination regarding the ordinal nature of the categorical predictor is made, the process of generating valid pairs can be more contextually informed. This generation process would be tailored to the specific characteristics of the predictor, thus optimizing the relevance and applicability of the pairs in subsequent analyses or operations. Ensuring that the generation process aligns with the predictor's nature may be helpful for the validity of any conclusions drawn downstream.

In some embodiments, for example, if the categorical predictor is ordinal, a valid pair may be identified as two adjacent categories with category importance values below a threshold. This approach leverages the inherent order in the predictor, ensuring the validity of the paired categories in the context of their ordinal relationship. In contrast, in some embodiments, if the categorical predictor is not ordinal, a valid pair may be identified as any two categories with category importance values below a predetermined threshold. This flexibility arises from the absence of a binding order in nominal predictors, granting more latitude in how categories can be effectively paired. The predefined thresholds could be determined using optimization techniques, or they may be determined beforehand and may be present in the metadata (e.g., as “high,” “medium,” and “low” category importance values).

Illustrative embodiments provide for identifying hybrid valid pairs associated with the hybrid category, testing another merge strategy for these hybrid pairs, and merging a valid hybrid pair to form another hybrid category. The ultimate goal of this process may be to take a valid hybrid pair and further combine them, culminating in the formation of an even more encompassing hybrid category. This iterative process may enable the embodiments to repeat any of the aforementioned steps to further merge hybrid categories until a convergence is reached. This recursive nature ensures that hybrid categories are further analyzed, refined, and, if necessary, merged again. This looping may continue until a state of equilibrium or convergence is achieved, ensuring that the merging process has been executed to its fullest extent, thereby optimizing the categorization scheme for the predictive model in question.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for post-modeling category merging is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

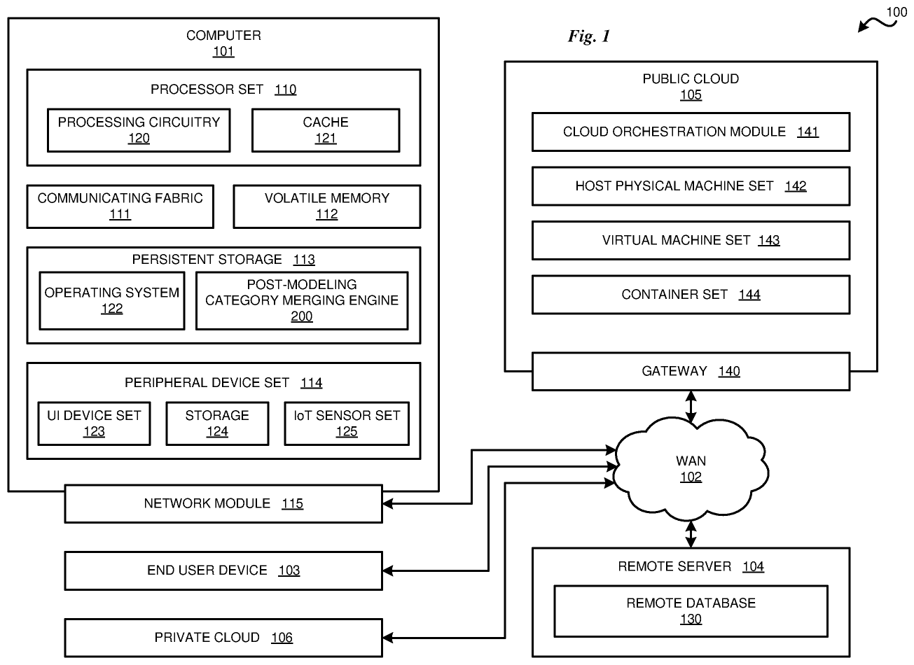

With reference to FIG. 1, this figure depicts a block diagram of a computing environment 100. Computing environment 100 contains an example of an environment for the execution of at least some of the computer code involved in performing the inventive methods, such as post-modeling category merging engine 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

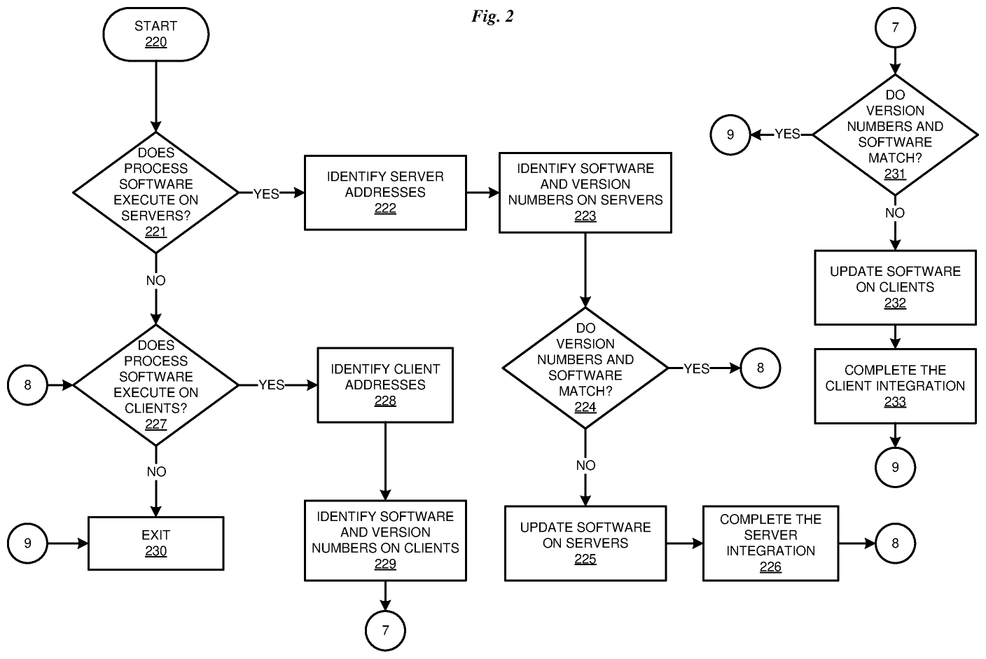

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

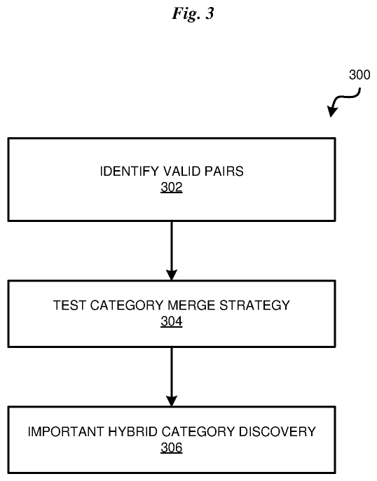

With reference to FIG. 3, this figure depicts a block diagram of an example process for post-modeling category merging in accordance with an illustrative embodiment 300. The example block diagram of FIG. 3 may be implemented using post-modeling category merging engine 200 of FIG. 1.

In the depicted embodiment, at block 302, the process may perform identification of valid pairs. This process may leverage metadata information and/or category importance values. As an illustrative example, the process might first identify categories that are explicitly defined in the metadata but find no representation in the training data. Such idle categories could be combined into a singular category to streamline the dataset. Furthermore, when dealing with ordinal predictors, the process may re-order categories once idle ones are merged and subsequently set aside. It may then earmark two adjacent categories with either low or medium category importance values as a valid pair. On the other hand, for nominal predictors, categories with high category importance values may be excluded. From the remaining categories, any two non-idle ones could be combined to form a valid pair. Category importance values may be computed using any suitable algorithm, such as outlined in U.S. application Ser. No. 18/333,510.

For example, when the process identifies valid pairs, it might employ one or more algorithms that scan the metadata, cross-referencing each category with the actual dataset. In the scenario where the process identifies idle categories, it may utilize a specialized merging algorithm. This algorithm may cluster these idle categories based on shared metadata properties to form a unified category, ensuring that data integrity is maintained. When the process encounters ordinal predictors, it might employ a sorting mechanism based on ranking metadata, ensuring that categories are systematically arranged. For nominal predictors, a filtering process may be applied to remove high importance categories, after which a combination matrix may be constructed, allowing the process to systematically evaluate all potential category pairings for validity.

At block 304, the process may test a category merging strategy, which may involve focusing on how a merger might influence model accuracy. Initially, the process may compute the change in model accuracy for each potential merging pair. Should no valid pairs exist, the process may transition to the discovery of significant hybrid categories. Here, the merging strategy chosen may be the one that incurs the least loss in accuracy, provided this loss remains under a predefined threshold. Once the process ascertains this accuracy change (which could also manifest as an accuracy gain) for merging a valid pair, it may proceed to sort such pairs in decreasing order based on the resultant change in model accuracy. The topmost pair may thereafter undergo the merging process to form the hybrid category. The process may then remove all pairs containing any category from the initially selected pair from its list. If valid pairs remain, the process may cycle back and repeat the process. If not, it may form valid pairs for each new hybrid category and reinitiate the process.

For example, the computation of accuracy changes for each potential merging might use delta analysis, comparing the performance metrics of the original model against a merged-category version. The predefined accuracy loss threshold can be determined using optimization techniques like gradient descent or the like. The sorting algorithm, when ordering pairs based on accuracy change, might rely on a weighted comparison, giving priority to pairs that maintain high accuracy while simplifying the feature space the most. Furthermore, post-merge, a reference registry could be maintained, logging all merged categories to ensure seamless removal of related pairs from the valid pair list.

At block 306, the process may perform discovery of potentially significant categories derived from the newly identified hybrid categories. Because the merging process might lead to the formation of categories with distinct patterns or behaviors in relation to the target variable, recognizing these could offer further insights into data understanding. This phase may leverage techniques like multivariate analysis and hierarchical clustering to dissect the emergent structures. By applying one or more algorithms outlined in U.S. application Ser. No. 18/333,510, for instance, the process can effectively categorize these emergent behaviors and assign category importance scores. Delving deep into this systematic examination ensures a thorough exploration of the latent spaces introduced by category merging. This may not only augment the granularity of the model's interpretative framework but may also optimize its predictive prowess through refined feature engineering.

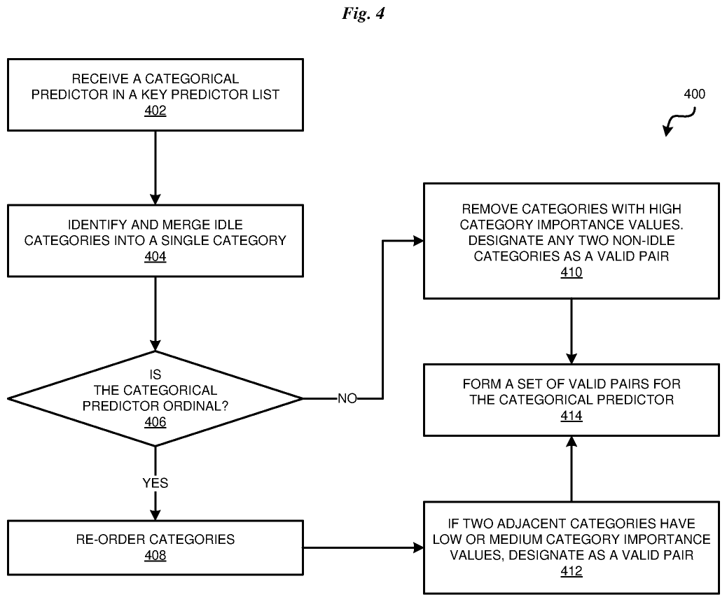

With reference to FIG. 4, this figure depicts a block diagram of an example process for identification of valid pairs in accordance with an illustrative embodiment 400. The example block diagram of FIG. 4 may be implemented using post-modeling category merging engine 200 of FIG. 1.

In the illustrative embodiment, at block 402, the process may select a categorical predictor from a key predictor list. The key predictor list may be a curated list or set of categorical predictors that are considered significant for a particular data analysis or modeling task. Predictors, in the context of data analysis and modeling, may be input variables or features that help in predicting or explaining the outcome variable. With a large dataset with many features or variables, not all of them might be equally relevant or significant. Hence, a key predictor list may be a refined list of predictors that have been identified as most impactful or relevant. However, in some embodiments, the process may iterate through all predictors obtained, for example, from the training data or metadata, without first filtering through them to identify key predictors.

This process may help ensure that the subsequent processes are based on pertinent data elements, thereby maintaining the integrity and relevance of the entire procedure. For example, the process may iteratively process a key predictor list, selecting each categorical predictor in order and processing it as further explained herein. As another example, the process might employ algorithms that prioritize predictors based on their historical relevance or potential impact on the outcome. These algorithms could take into account the frequency, distribution, and variance of categories within each predictor to make an informed choice, among other information.

At block 404, the process may identify and merge idle categories into a single category. This process may involve identifying categories explicitly defined in the metadata. If a category does not have any records in the training data, for instance, they may be regarded as “idle.” The process may consolidate these idle categories into a singular, consolidated category, thereby simplifying the data structure and eliminating redundant or non-contributory elements. For example, during the merging of idle categories, the process could utilize a database query mechanism that runs a scan on the training dataset against the metadata definitions. By tallying the count of records associated with each category and isolating those with a count of zero, this method may ensure that no category is overlooked during the merger, preserving data integrity.

At block 406, the process may determine whether the categorical predictor is ordinal. In this context, “ordinal” may refer to a type of data that represents categories with a specific order or ranking. Unlike “nominal” data, which consists of categories that do not have a meaningful order (e.g., colors, types of fruits, etc.), ordinal data categories have a distinct sequence. For instance, the categories “low,” “medium,” and “high” may be ordinal in nature because they indicate a progression in levels. Another example could be educational levels like “elementary school,” “high school,” and “college.” These categories have a clear order: completing high school comes after completing elementary school and before attending college. Understanding if a predictor is ordinal may mean determining if its categories possess a specific order or hierarchy. In some embodiments, whether a predictor is ordinal may be determined from its metadata, such as when the metadata identifies whether a particular category is ordinal or nominal. In some other embodiments, however, one or more algorithms may be used to dynamically determine whether the categories are ordinal, such as by applying a classification algorithm that classifies a set of categories into ordinal or nominal. This distinction may be helpful because the order might impact the analysis or the modeling process. For example, in the phase of determining the nature of the predictor, the process might refer to metadata tags or employ statistical methods to analyze the data distribution. Ordinality checks could involve inspecting for inherent sequence patterns or referencing predefined ordinal indicators that might be embedded within the data schema.

If the predictor is found to be ordinal, at block 408, the process, following the merging of idle categories, may perform a reordering of categories. This restructuring may help ensure that the inherent order of categories is preserved and reflects accurate hierarchical relationships. For instance, in an ordinal dataset representing shirt sizes such as “S,” “M,” “L,” “XL,” “XXL,” and “XXXL,” after the merging of idle categories such as “L” and “XXXL,” the process may reorder of the remaining categories. Thus, the process may ensure that the categories “S,” “M,” “XL,” and “XXL” are reordered in that order to represent their inherent size progression. By doing so, the process may help ensure that any downstream analytical or operational task comprehends this logical size progression, guaranteeing data integrity and contextual relevance.

At block 410, the process may designate as a valid pair two adjacent categories, if they have either low or medium category importance values. This pairing strategy may help emphasize the significance of closely related categories in an ordinal setup. For example, when handling ordinal predictors, the reordering mechanism might utilize sorting algorithms that factor in both the inherent ordinal nature and any external weightage or hierarchy definitions specified in the metadata.

Conversely, if the predictor is found to be non-ordinal, the process, at block 412, may remove categories with high category importance values. From the categories that remain, any two non-idle ones may be paired together to form a valid pair. This process underscores the flexibility and adaptability of the process when working with different types of predictors. For example, the elimination of high category importance values might involve setting dynamic thresholds, which could be adjusted based on the overall distribution of importance values across all categories. The subsequent pairing might employ combinatorial algorithms to ensure optimal pair generation, while also eliminating any redundancy or overlap in pairings.

At block 414, the process may produce a set of valid pairs as a result of the processing of the categorical predictor(s). For example, the process might store these pairs in structured data tables or matrices. These data structures could be optimized for quick retrieval and might be equipped with meta tags that offer insights into the origin, nature, and relevance of each valid pair, thereby facilitating deeper analytical processes down the line.

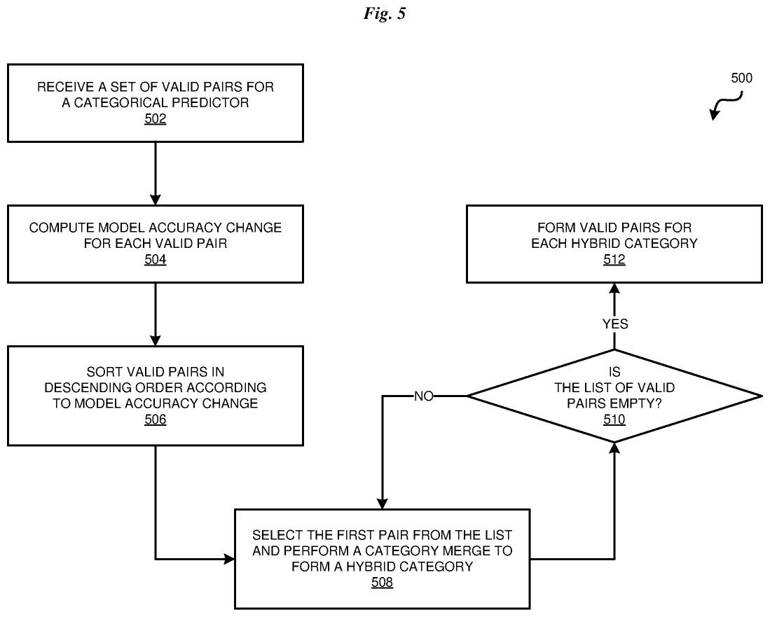

With reference to FIG. 5, this figure depicts a block diagram of an example process for testing a category merging strategy in accordance with an illustrative embodiment 500. The example block diagram of FIG. 5 may be implemented using post-modeling category merging engine 200 of FIG. 1.

In the illustrative embodiment, at block 502, the process may receive a set of valid pairs related to a particular categorical predictor. This dataset may have been processed, as explained previously, ensuring it is devoid of any redundant or infeasible pairs, thereby creating a foundational basis for the subsequent analytical operations. For example, algorithms such as those described in connection with FIG. 4 could be deployed. Moreover, these algorithms might employ heuristic checks and metadata cross-referencing, among other functions, to prune irrelevant or redundant pairs, ensuring that the resultant set is both concise and meaningful.

At block 504, the process may compute the change in model accuracy attributable to the merging of each potential pair within the dataset. This process may involve applying statistical metrics or any other suitable processes to compute this change, and it may integrate iterative feasibility checks. For example, considering predictor X₁ with R categories interacting with target Y having S categories, the value for a table cell (x,y) may represent the count of records aligning with the (x,y) value pair. When analyzing a valid pair, such as {x_{1,r}, X_{1,k}}, one of two merging strategies may be employed: merging X₁=x_{1,r} into category X₁=x_{1,k}, or vice versa. The process may then compute and apply the strategy yielding minimal accuracy loss, provided this loss remains below a predetermined threshold. It is this delta, which could also occasionally represent an accuracy gain, that denotes the accuracy change consequent to the merging of a valid pair. If both merging directions fail to meet the threshold criteria, the pair may be deemed infeasible for merging. To illustrate, consider the act of merging the 2nd category value into the 1st. In such a scenario, any record where Feature X₁ takes the value x_{1,r} would be reassigned the value x_{1,k}, thereby possibly influencing the model's accuracy. Thus, the r-th category value might be merged into the k-th one, leading to iterative refinements in model performance. Other methods to compute the change in model accuracy post-merging may be used, however, such as statistical or machine learning. These metrics could be based on factors like F1 score, precision, recall, or measures like area under the ROC curve, catering to both binary and multi-class classification scenarios. Such precision may help ensure that the perceived change in accuracy is both robust and contextually relevant. If a pair is determined as non-compatible or does not align with the merging criteria, the process may perform important category discovery.

At block 506, the process may sort the valid pairs in descending order based on model accuracy change. This stratification, which may be implemented using any suitable sorting algorithm, may help ensure that pairs inducing the most significant accuracy shifts are prioritized in the subsequent operations. Moreover, the sorting algorithms could integrate weighted scoring systems where pairs with similar accuracy changes are further ranked based on secondary criteria, such as their prevalence in the dataset or their historical significance, ensuring a more nuanced sorting outcome.

At block 508, the process may select the first pair from the list and perform a category merge to form a hybrid category. Once identified, this pair may undergo a merging operation, which may involve utilizing data transformation techniques and mathematical formulations to amalgamate the distinctive attributes and value distributions of the two categories. The merging may respect data hierarchies, ensuring that any intrinsic order or relational dependencies within the categories are preserved. This consolidated category may not only optimize data representation but also streamline computational tasks, ensuring that the model operates with heightened efficiency in subsequent analytical stages. After this synthesis, to avoid redundancy and potential data conflicts, all pairs containing any element of the merged pair may be programmatically removed from the dataset. Concurrently, the merged pair may also be dequeued from the set of valid pairs, refining the list for the ensuing steps. Moreover, the removal of associated pairs from the list could be expedited using hash maps or indexed databases, ensuring that the process is both swift and resource-efficient.

At block 510, the process may evaluate the residual dataset for any remaining valid pairs. If the outcome of this check, confirms the exhaustion of pairs, the proceed to the subsequent block. Evaluating the residual dataset for any remaining valid pairs may involve applying one or more algorithms and/or data structures. For instance, the process might utilize a dynamic array or linked list to house the current pairs, in addition to employing a hashing mechanism, with each pair being hashed to a distinct value. Any other process may be used, however, as would be appreciated by those having ordinary skill in the art upon reviewing the present disclosure.

At block 512, the process may form a set of valid pairs for each hybrid category as a result of the processing of valid pair(s). If, however, the dataset still retains valid pairs, the process may loop back to block 508. This iterative mechanism may guarantee a comprehensive and exhaustive assessment and merger of all potential category pairs, optimizing the granularity and efficacy of the merging strategy. For example, the process could employ recursive functions or iterative loops optimized with break conditions. These conditions might be based on factors like the number of iterations, convergence criteria, or the stability of the model's accuracy, ensuring that the process operates within optimal bounds and avoids potential pitfalls like infinite loops or computational bottlenecks.

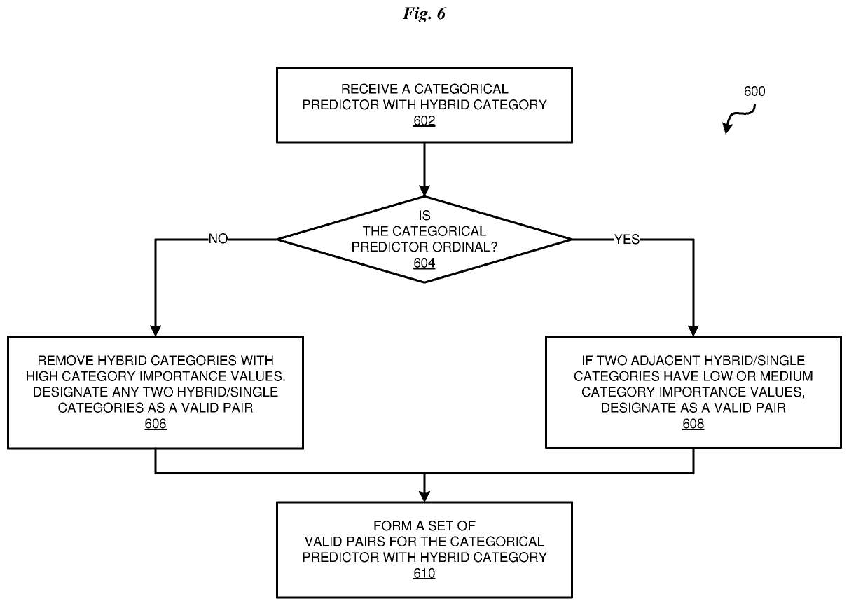

With reference to FIG. 6, this figure depicts a block diagram of an example process for forming a set of valid pairs for a hybrid category in accordance with an illustrative embodiment 600. The example block diagram of FIG. 6 may be implemented using post-modeling category merging engine 200 of FIG. 1.

In the illustrative embodiment, at block 602, the process might select a categorical predictor with one or more hybrid categories. Having been subjected to prior stages of evaluation and transformation, this predictor may now be primed for further analysis as a result of comprising hybrid categories that may be further merged. A hybrid-identification phase, such as that outlined in connection with FIG. 5, might have been performed prior to this process. Other methods for identifying and generating predictors with hybrid categories may be used however, such as methods involving anomaly detection, statistical outlier identification, or domain-specific checks to ascertain that the hybrid categories are both present and relevant.

At block 604, the process may determine whether the categorical predictor is ordinal. As previously noted, this distinction may revolve around the fact that ordinal predictors have inherent order, and their processing may differ from nominal predictors. This determination may be based on metadata or a dynamic processing of the predictor, as previously explained. For example, the verification of ordinality might involve a label-based check. Additionally or alternatively, techniques like Spearman's rank correlation coefficient or trend analysis could be invoked to validate the inherent order of the categories, ensuring that subsequent operations are tailored to maintain this ordinal relationship.

At block 606, if the predictor is not ordinal, high category importance value hybrid categories may be removed, streamlining the remaining categories for pairing. The category importance values may be computed, for example, by applying one or more algorithms outlined in U.S. application Ser. No. 18/333,510, although any other suitable algorithm may be used. The removal of high category importance categories might incorporate methods like z-score normalization or percentile-based cutoffs. Subsequently, any two remaining hybrid or single categories may be used to form a valid pair.

In the scenario where the predictor is determined to be ordinal at block 608, a hybrid or single category with low or medium category importance value may then be paired with its adjacent counterpart. This pairing may leverage the inherent order of the categories to derive meaningful insights. Moreover, the pairing process might take into consideration not just immediate adjacency but also the weightage or significance of the categories. Methods like weighted graph analysis or proximity-based clustering might be employed to ensure that the paired categories truly reflect their relative importance and proximity.

At block 610, the process may result in a set of valid pairs for the categorical predictor with one or more hybrid categories. Thereafter, the process may repeat iteratively until a convergence is reached or until no more valid pairs may be computed from the various hybrid categories. On every subsequent run, the process may reevaluate the newly formed hybrid categories, check for further potential pairings, and remerge into new hybrid categories. This recursive nature of the process may help ensure a comprehensive merging strategy, maximizing the coherence of the categories. The iterations may continue until a state of equilibrium is achieved, which could be marked by a convergence in model accuracy or when the process discerns that no more valid pairs can be generated from the existing set of hybrid categories. Such an approach may help ensure that the merging process is exhaustive.

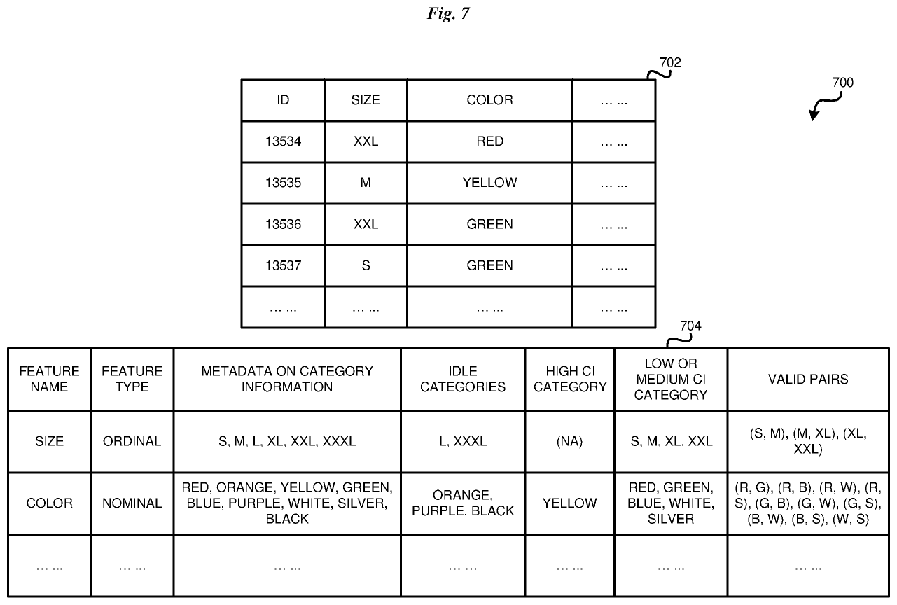

With reference to FIG. 7, this figure depicts an example result of identifying valid pairs 700. It is to be understood that the process of identifying valid pairs may be performed using any other suitable process than the process explained in connection with this illustrative embodiment.

In the depicted example, table 702 may represent an initial set of data, which may include an identification column, a size column, and a color column, although it may contain additional information. Each identification in the identification column may correspond to a unique data point. For instance, the data point with identifier “13534” is characterized by the attributes “XXL” in the size column and “Red” in the color column, as showcased in the first row. Similarly, the identifier “13535” is associated with the categorical attributes “M” in size and “Yellow” in color. Likewise, identifier “13536” corresponds to size “XXL” and color “Green,” while “13537” corresponds to size “S” and color “Green.”

Table 704 may include metadata associated with the data of table 702, and it may represent the result of processing the data of table 702 to identify valid pairs. As shown, for example, for the “Size” feature, the metadata indicates its type as “Ordinal.” This determination might be derived from pre-existing metadata tags or through the application of classification algorithms, as explained previously. Based on the data of table 702, from the categories for this feature, ranging from “S” to “XXXL,” the process may flag “L” and “XXXL” as idle as no entry in table 702 includes these categories. That is, any category with a zero record count may be marked as idle. Next, given the ordinal nature of the “Size” feature, the process may re-order the remaining non-idle categories to maintain their inherent sequence. As a result, the sequence “S,” “M,” “XL,” and “XXL” may be established, preserving the logical size progression. From this re-ordered sequence, the valid pairs of (S, M), (M, XL), and (XL, XXL) may be formed for the “Size” feature. This is because there are no categories with high category importance for this particular feature (and thus no categories need be filtered out), and the remaining adjacent categories may be grouped into valid pairs as they all have either low or medium high category importance.

On the other hand, the “Color” feature may be classified as “Nominal,” indicating the absence of an intrinsic order. The categories of Orange, Purple, and Black may be identified as idle, since table 702 does not include any entries having that color. After removing the high category importance category of Yellow, any remaining non-idle categories consisting of Red, Green, Blue, White, and Silver may be used to form a valid pair. Thus, the valid pairs consist of (Red, Green), (Red, Blue), (Red, White), (Red, Silver), (Green, Blue), (Green, White), (Green, Silver), (Blue, White), (Blue, Silver), and (White, Silver).

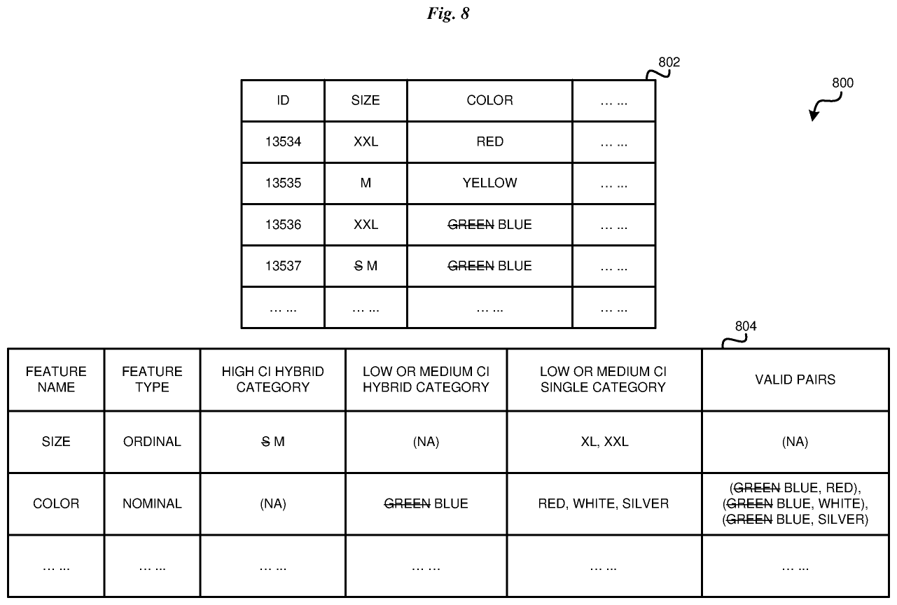

With reference to FIG. 8, this figure depicts an example result of merging valid pairs to generate hybrid categories 800. It is to be understood that the process of merging valid pairs may be performed using any other suitable process than the process explained in connection with this illustrative embodiment.

In the depicted example, table 802 may represent a set of data with hybrid categories. As shown, for example, table 802 includes merged sizes “S” and “M,” depicted by hybrid category “M,” with the strikethrough denoting that size “S” has been merged into size “M.” However, size “M” could have been merged into size “S,” resulting in the same outcome. This merging decision may have been the outcome of a merge strategy test showing that merging these two categories results in the highest accuracy increase (or least accuracy decrease) as a result of the merging. The same rationale may be applied to hybrid category “Blue,” with the strikethrough denoting that color Green has been merged into color Blue.

Table 804 may represent the result of identifying valid pairs from the hybrid categories. As shown, for example, for the “Size” feature, based on the fact that its type is “Ordinal,” the process may attempt to generate valid pairs from any adjacent categories with low or medium category importance values. However, as shown, because there are no such hybrid categories with either low or medium category importance values (and categories “XL” and “XXL” were previously processed), there may be no valid pairs for this categorical predictor.

With respect to the “Color” feature, however, the hybrid category “Blue” may be given a low or medium category importance value. Thus, because this feature has a type of “Nominal,” it may be paired with any other hybrid or single category with a low or medium category importance value, consisting of Red, White, and Silver. The possible pairings thus result in (Blue, Red), (Blue, White), and (Blue, Blue).

With reference to FIG. 8, this figure depicts an example result of merging valid pairs of a categorical predictor with hybrid categories 900. It is to be understood that the process of merging valid pairs may be performed using any other suitable process than the process explained in connection with this illustrative embodiment.

In the depicted example, table 902 may represent a set of data with further merged hybrid categories. As shown, for example, table 902 includes merged sizes “S” and “M,” depicted by hybrid category “M,” and merged colors Green and Blue, depicted by hybrid category “Blue,” as explained before. Furthermore, table 902 includes another hybrid category “Blue,” denoting that the color Red has been merged into color Blue.

This determination may result from the iterative process of merging valid pairs of a categorical predictor with hybrid categories as illustrated by table 904. As shown, with respect to the color feature, all categories except for Yellow (i.e., Green, Red, Green, Blue, White, and Silver), may have been merged with Blue, represented by hybrid category “Blue,” although the merging may have taken place in a different order (e.g., Blue merging into White, etc.). Thus, the process may result in a binary decision for the color feature with respect to post-modeling merging: either Yellow or non-Yellow (e.g., “Blue”).

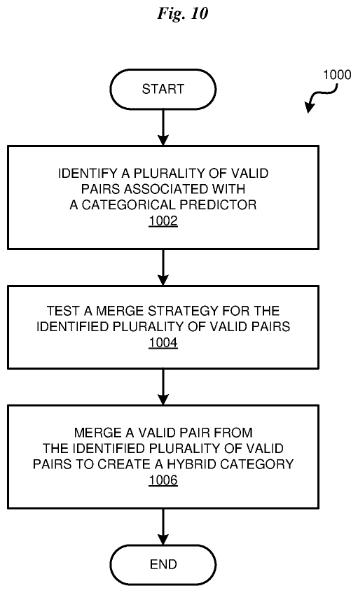

With reference to FIG. 10, this figure depicts a block diagram of an example process for post-modeling category merging in accordance with an illustrative embodiment 1000. The example block diagram of FIG. 7 may be implemented using post-modeling category merging engine 200 of FIG. 1.

In the illustrative embodiment, at block 1002, the process involves identifying a plurality of valid pairs associated with a categorical predictor. These valid pairs represent potential mergers of categories connected with a categorical predictor of a predictive model. At block 1004, the process tests a merge strategy for the identified plurality of valid pairs. The aim of this testing may be to determine a merger that minimizes a potential loss in accuracy for the predictive model. At block 1006, based on the outcomes of the testing in block 1004, the process merges a valid pair from the identified plurality of valid pairs to create a hybrid category. It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
identifying, by a post-modeling category merging engine, a plurality of valid pairs associated with a categorical predictor, the plurality of valid pairs representing potential mergers of categories associated with a categorical predictor of a predictive model;
testing, by the post-modeling category merging engine, a merge strategy for the plurality of valid pairs to determine a merger that minimizes a loss in accuracy of the predictive model; and
merging, by the post-modeling category merging engine based on the testing, a valid pair in the plurality of valid pairs to form a hybrid category.

2. The method of claim 1, wherein identifying the plurality of valid pairs further comprises:
identifying a plurality of idle categories representing underutilized categories associated with the categorical predictor;
merging the plurality of idle categories; and
generating, based on a plurality of category importance values associated with a plurality of non-idle categories, the plurality of valid pairs.

3. The method of claim 2, wherein identifying the plurality of idle categories further comprises:
identifying a category as idle responsive to a determination that the category includes a zero count in a training dataset associated with the predictive model.

4. The method of claim 2, wherein generating the plurality of valid pairs based on the plurality of category importance values further comprises:
determining whether the categorical predictor is ordinal; and
identifying as a valid pair, responsive to a determination that the categorical predictor is ordinal, two adjacent categories having a category importance value below a predetermined threshold.

5. The method of claim 4, further comprising:
identifying as a valid pair, responsive to a determination that the categorical predictor is not ordinal, any two categories having a category importance value below a predetermined threshold.

6. The method of claim 1, wherein testing the merge strategy to determine the merger that minimizes the loss in accuracy of the predictive model further comprises:
computing a plurality of model accuracy changes for a plurality of categories associated with the categorical predictor;
sorting the plurality of model accuracy changes based on change magnitude;
identifying a minimum model accuracy change in the sorted plurality of model accuracy changes; and
determining to merge two categories associated with the minimum model accuracy change.

7. The method of claim 6, wherein the minimum model accuracy change is associated with a minimal decrease in accuracy for the predictive model.

8. The method of claim 6, wherein the minimum model accuracy change is associated with a maximum increase in accuracy for the predictive model.

9. The method of claim 1, further comprising:
identifying, by the post-modeling category merging engine, a plurality of hybrid valid pairs associated with the hybrid category of the categorical predictor;
testing, by the post-modeling category merging engine, another merge strategy for the plurality of hybrid valid pairs to determine another merger that minimizes the loss in accuracy of the predictive model; and
merging, by the post-modeling category merging engine based on the testing, a valid hybrid pair in the plurality of hybrid valid pairs to form another hybrid category.

10. A computer program product comprising one or more computer readable storage media, and program instructions collectively stored on the one or more computer readable storage media, the program instructions executable by a processor to cause the processor to perform operations comprising:
identifying, by a post-modeling category merging engine, a plurality of valid pairs associated with a categorical predictor, the plurality of valid pairs representing potential mergers of categories associated with a categorical predictor of a predictive model;
testing, by the post-modeling category merging engine, a merge strategy for the plurality of valid pairs to determine a merger that minimizes a loss in accuracy of the predictive model; and
merging, by the post-modeling category merging engine based on the testing, a valid pair in the plurality of valid pairs to form a hybrid category.

11. The computer program product of claim 10, wherein identifying the plurality of valid pairs further comprises:
identifying a plurality of idle categories representing underutilized categories associated with the categorical predictor
merging the plurality of idle categories; and
generating, based on a plurality of category importance values associated with a plurality of non-idle categories, the plurality of valid pairs.

12. The computer program product of claim 11, wherein identifying the plurality of idle categories further comprises:
identifying a category as idle responsive to a determination that the category includes a zero count in a training dataset associated with the predictive model.

13. The computer program product of claim 11, wherein generating the plurality of valid pairs based on the plurality of category importance values further comprises:
determining whether the categorical predictor is ordinal; and
identifying as a valid pair, responsive to a determination that the categorical predictor is ordinal, two adjacent categories having a category importance value below a predetermined threshold.

14. The computer program product of claim 13, further comprising:
identifying as a valid pair, responsive to a determination that the categorical predictor is not ordinal, any two categories having a category importance value below a predetermined threshold.

15. The computer program product of claim 10, wherein testing the merge strategy to determine the merger that minimizes the loss in accuracy of the predictive model further comprises:
computing a plurality of model accuracy changes for a plurality of categories associated with the categorical predictor
sorting the plurality of model accuracy changes based on change magnitude
identifying a minimum model accuracy change in the sorted plurality of model accuracy changes; and
determining to merge two categories associated with the minimum model accuracy change.

16. The computer program product of claim 10, further comprising:
identifying, by the post-modeling category merging engine, a plurality of hybrid valid pairs associated with the hybrid category of the categorical predictor
testing, by the post-modeling category merging engine, another merge strategy for the plurality of hybrid valid pairs to determine another merger that minimizes the loss in accuracy of the predictive model; and
merging, by the post-modeling category merging engine based on the testing, a valid hybrid pair in the plurality of hybrid valid pairs to form another hybrid category.

17. A computer system comprising a processor and one or more computer readable storage media, and program instructions collectively stored on the one or more computer readable storage media, the program instructions executable by the processor to cause the processor to perform operations comprising:
identifying, by a post-modeling category merging engine, a plurality of valid pairs associated with a categorical predictor, the plurality of valid pairs representing potential mergers of categories associated with a categorical predictor of a predictive model;
testing, by the post-modeling category merging engine, a merge strategy for the plurality of valid pairs to determine a merger that minimizes a loss in accuracy of the predictive model; and
merging, by the post-modeling category merging engine based on the testing, a valid pair in the plurality of valid pairs to form a hybrid category.

18. The computer system of claim 17, wherein identifying the plurality of valid pairs further comprises:
identifying a plurality of idle categories representing underutilized categories associated with the categorical predictor
merging the plurality of idle categories; and
generating, based on a plurality of category importance values associated with a plurality of non-idle categories, the plurality of valid pairs.

19. The computer system of claim 18, wherein identifying the plurality of idle categories further comprises:
identifying a category as idle responsive to a determination that the category includes a zero count in a training dataset associated with the predictive model.

20. The computer system of claim 17, further comprising:
identifying, by the post-modeling category merging engine, a plurality of hybrid valid pairs associated with the hybrid category of the categorical predictor
testing, by the post-modeling category merging engine, another merge strategy for the plurality of hybrid valid pairs to determine another merger that minimizes the loss in accuracy of the predictive model; and
merging, by the post-modeling category merging engine based on the testing, a valid hybrid pair in the plurality of hybrid valid pairs to form another hybrid category.
